(19) United States
(12) Patent Application Publication
(10) Pub. No.: US 2026/0362114 A1
(43) Pub. Date: Nov. 12, 2026

(54) NETWORK FUNCTIONS AND METHODS FOR ENHANCED MANAGEMENT OF USER SEGMENT WITH NF GROUP ID

(71) Applicant: Telefonaktiebolaget LM Ericsson (publ), Stockholm (SE)

(72) Inventors: Lin JIN, Shanghai (CN); Yunjie LU, Shanghai (CN); Xiaowei ZHANG, Shanghai (CN); Emiliano MERINO VAZQUEZ, Leganés, Madrid (ES); Jesús Ángel DE GREGORIO RODRIGUEZ, Boadilla Del Monte, Madrid (ES)

(73) Assignee: Telefonaktiebolaget LM Ericsson (publ), Stockholm (SE)

(21) Appl. No.: 19/470,200

(22) PCT Filed: Mar. 15, 2024
(86) PCT No.: PCT/CN2024/081900

§ 371 Date: Sep. 29, 2025

(30) Foreign Application Priority Data
Mar. 31, 2023 (WO) PCT/CN2023/085734

(51) Int. Cl. H04W 8/08; H04W 8/18

(52) U.S. Cl. CPC H04W 8/08; H04W 8/186

(57) ABSTRACT

Techniques for enhanced management of user segment with NF Group ID are provided. A method (100) in first NF may include receiving (S102), from a second NF, a notification of a change in a mapping between NF Group ID and UE identity stored in the second NF. A method (200) in the second NF may include sending (S202), to the first NF, the notification of a change in a mapping between NF Group ID and UE identity stored in the second NF, when a mapping change occurs in the second NF.

### TECHNICAL FIELD

The present disclosure relates generally to the field of communication networks, and more specifically to techniques for enhanced management of user segment with Network Function (NF) Group ID.

### BACKGROUND

According to the description in 3GPP TS 23.501 V17.5.0, for some Network Functions which have access to subscription data (e.g. HSS (Home Subscriber Server), UDM (Unified Data Management)), NRF (NF Repository Function) may need to resolve NF Group ID corresponding to a subscriber identifier. If the NRF has not stored configuration mapping identity sets/ranges to NF Group ID locally, the NRF may retrieve the NF Group ID corresponding to a specific subscriber identifier from UDR (User Data Repository) using the Nudr_GroupIDmap_Query service operation.

So first a NF Consumer can perform a discovery operation with UE identity, and the NRF will return the NF Group ID only in the discovery result if the mapping of UE identities and NF Group ID is provided by the UDR. Then later the NF Consumer can perform a discovery of target NF Producers (e.g., UDM, PCF (Policy Control function), AUSF (Authentication Service Function)) with the NF Group ID, instead of UE identity (e.g., SUPI (SUbscription Permanent Identifier)). The corresponding NF Group ID can also be transferred between the specific NF Consumers (e.g., source AMF (Access and Mobility Management Function) and target AMF).

For delegate discovery, SCP (Service Communication Proxy) may interact with the NRF to perform discovery and obtain discovery result with NF Group ID corresponding to the UE identifier retrieved from the UDR as discovery input.

### REFERENCES

[1] 3GPP TS 29.510 V17.7.0;
[2] 3GPP TS 23.501 V17.5.0;
[3] 3GPP TS 23.502 V17.5.0;
[4] 3GPP TS 29.504 V17.8.0.

### SUMMARY

Based on the current 3GPP specifications, such as 3GPP TS 29.504 V17.8.0., the Nudr_GroupIDmap service allows NF Consumers (i.e. NRF or SCP) of UDR to retrieve mapping between a given subscriber ID and NF Group ID (NF type+Group ID) that handles it. However, it is currently not possible for NF Consumers to subscribe to or be notified about any change on such mapping in UDR. Further, the NRF provides the NF Group ID to a NF Consumer, without the UE Identity (e.g. SUPI) Ranges in the discovery result when the mapping of UE identity and NF Group ID is provided by the UDR. If there is any change on the mapping of UE identity and NF Group ID in the UDR, which might be triggered from the O&M (Operation and Maintenance) by the operator, then the NRF or SCP cannot be notified about the change of mapping, and even not further update to the NF consumer via the NRF or other NFs. As a result, the NF Consumer/SCP would send service request to an incorrect NF producer.

There is a need for mechanisms of notifying the change of mapping in the UDR to the NF consumer/NRF/SCP, which has not been specified in the current 3GPP standard yet. For example, it will be useful for a NF Consumer to subscribe such mapping with UDR and thus UDR will send to the NF Consumer a notification of a change in the mapping when the mapping changes.

In some embodiments, a method in a first NF may include at least one of: receiving, from a second NF, a notification of a change in a mapping between NF Group ID and UE identity stored in the second NF; and/or updating mapping information stored in the first NF in response to receiving, from a second NF, a notification of a change in a mapping between NF Group ID and UE identity stored in the second NF.

In some embodiments, a method in a first NF may include sending, to a second NF, a subscription request for subscribing a notification of a change in a mapping between NF Group Identifier (ID) and UE identity stored in the second NF.

In some embodiments, a method in a second NF may include sending, to a first NF, a notification of a change in a mapping between NF Group ID and UE identity stored in the second NF, when a mapping change occurs in the second NF.

In some embodiments, a method in a second NF may include receiving, from a first NF, a subscription request for subscribing a notification of a change in a mapping between NF Group Identifier (ID) and UE identity stored in the second NF.

In some embodiments, a method in a NF consumer may include: sending, to NRF, a discovery request with a UE identity corresponding to a UE request from a UE; and receiving, from the NRF, a discovery response including an NF Group ID mapped to the UE identity and additional information. The additional information may indicate a mapping source which provides mapping between the NF Group ID and the UE identity.

In some embodiments, a method in a NRF may include: receiving, from a NF consumer, a discovery request with a UE identity corresponding to a UE request from a UE; and sending, to the NF consumer, a discovery response including an NF Group ID mapped to the UE identity and additional information.

In some embodiments, a Network Function (NF) may be implemented as include a processor; and a memory coupled to the processor. The memory may contain instructions executable by the processor, whereby the NF is operative to perform operations corresponding to any of the above methods.

In some embodiments, a non-transitory, computer-readable medium storing computer-executable instructions that, when executed by a processor of a NF, cause the NF to perform operations corresponding to any of the above methods.

In some embodiments, a computer program comprising instructions that, when executed on at least one processor of a NF, cause the NF to perform operations corresponding to any of the above methods.

In some embodiments, a carrier containing the above computer program, wherein the carrier is one of an electronic signal, optical signal, radio signal, or computer-readable medium.

The embodiments of the present disclosure provide the possibility for the NF Consumer/SCP/NRF to subscribe with or be notified about the change of mapping from the UDR, so the previous stored UE identity and NF Group ID can be updated. Then NF Consumer/SCP can utilize the new mapping to perform the discovery to find the correct target NF Producer handling the service request. Otherwise, the NF Consumer/SCP has to perform the discovery with the UE identity to find the correct NF instance for each service request or after the NF Consumer receives the failure response with additional implementation logic.

### BRIEF DESCRIPTION OF THE DRAWINGS

These and other objects, features, and advantages of the present disclosure will become apparent upon reading the following Detailed Description in view of the Drawings briefly described below.

FIG. 1 is a flowchart illustrating an exemplary method in a first NF of a communication network (e.g., 5GC) according to various embodiments of the present disclosure.

FIG. 2 is a flowchart illustrating an exemplary method in a second NF of a communication network (e.g., 5GC) according to various embodiments of the present disclosure.

FIG. 3 is a flowchart illustrating an exemplary method in a NF consumer of a communication network (e.g., 5GC) according to various embodiments of the present disclosure.

FIG. 4 is a flowchart illustrating an exemplary method in a NRF of a communication network (e.g., 5GC) according to various embodiments of the present disclosure.

FIG. 5 shows a flow of an exemplary subscribe/notify procedure according to various embodiments of the present disclosure.

FIG. 6 shows a flow of an exemplary discovery procedure according to various embodiments of the present disclosure.

FIGS. 7A and 7B show a flow of an exemplary direction communication procedure between NF consumer, NRF and UDR according to various embodiments of the present disclosure.

FIGS. 8A and 8B show a flow of an exemplary indirect communication procedure between NF consumer, SCP, NRF and UDR according to various embodiments of the present disclosure.

FIG. 9 is a schematic block diagram of a network node implementing NF of a communication network (e.g., 5GC) according to various embodiments of the present disclosure.

FIG. 10 shows a communication system according to various embodiments of the present disclosure.

FIG. 11 shows a UE according to various embodiments of the present disclosure.

FIG. 12 shows a network node according to various embodiments of the present disclosure.

FIG. 13 shows host computing system according to various embodiments of the present disclosure.

FIG. 14 is a block diagram of a virtualization environment in which functions implemented by some embodiments of the present disclosure may be virtualized.

FIG. 15 illustrates communication between a host computing system, a network node, and a UE via multiple connections, according to various embodiments of the present disclosure.

### DETAILED DESCRIPTION

Embodiments briefly summarized above will now be described more fully with reference to the accompanying drawings. These descriptions are provided by way of example to explain the subject matter to those skilled in the art and should not be construed as limiting the scope of the subject matter to only the embodiments described herein. More specifically, examples are provided below that illustrate the operation of various embodiments according to the advantages discussed above.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods and/or procedures disclosed herein do not have to be performed in the exact order disclosed, unless a step is explicitly described as following or preceding another step and/or where it is implicit that a step must follow or precede another step. Any feature of any of the embodiments disclosed herein can be applied to any other embodiment, wherever appropriate. Likewise, any advantage of any of the embodiments can apply to any other embodiments, and vice versa. Other objects, features and advantages of the disclosed embodiments will be apparent from the following description.

Furthermore, the following terms are used throughout the description given below:
Radio Access Node: As used herein, a “radio access node” or “radio network node” or “radio access network node” is any node in a radio access network of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit or a network node that implements a gNB Distributed Unit) or a network node that implements part of the functionality of some other type of radio access node.
Core Network Node: As used herein, a “core network node” is any type of node in a core network. Some examples of a core network node include, e.g., a Mobility Management Entity (MME), a serving gateway (SGW), a Packet Data Network Gateway (P-GW), etc. A core network node can also be a node that implements a particular core network function (NF), such as an access and mobility management function (AMF), a session management function (SMF), a user plane function (UPF), a Service Capability Exposure Function (SCEF), or the like.
Network Node: As used herein, a “network node” is any node that is part of the core network (e.g., a core network node discussed above) of a telecommunications network. Functionally, a network node is equipment capable, configured, arranged, and/or operable to communicate directly or indirectly with a wireless or wired device and/or with other network nodes or equipment in the telecommunications network, to enable and/or provide wireless or wired access to the telecommunication device, and/or to perform other functions (e.g., administration) in the telecommunications network.
Node: As used herein, the term “node” (without any prefix) can be any type of node that is capable of operating in or with a telecommunication network (including a RAN and/or a core network), including a radio access node (or equivalent term), core network node, or telecommunications device.

Note that the description given herein focuses on a 3GPP telecommunications system and, as such, 3GPP terminology or terminology similar to 3GPP terminology is generally used. However, the concepts disclosed herein are not limited to a 3GPP system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from the concepts, principles, and/or embodiments described herein.

In addition, functions and/or operations described herein as being performed by a telecommunications device or a network node may be distributed over a plurality of telecommunications devices and/or network nodes.

No mechanism of notifying the change of mapping in the UDR to the NF consumer/NRF/SCP has been specified in the current 3GPP standard yet. As a result, the NF Consumer/SCP will send service request to an incorrect NF producer, by using the out-of-date mapping previously known from the UDR, if any mapping change has been occurred in the UDR. For example, the UE may send a 5GC initial registration towards AMF, and the AMF may discover (via NRF) the UDMs serving the UE. When UDM discovery for the UE is received by NRF, NRF may check UDM NF profiles, which only contain the UDM GID (Group Identifier), without UE ranges. Hence, NRF queries UDR to obtain the UDM GID provisioned for the UE. When UDR returns the UDM GID for the requested UE, NRF may searches UDM profile whose GID (in udmInfo) matches the one obtained from the UDR. Then, NRF may respond to AMF with the UDM profiles found for the GID. AMF may store the UDM profiles and their GID as part of the UE mobility management context created after registering the UE in a selected UDM from the GID. Later, Operators may change the provisioned GID for the UE in UDR, and UDR mapping UE->UDM GID has then changed. The new UDM GID is identifying a different UDM pool to serve the UE. When AMF needs to update the UE registration in UDM, it selects a UDM from the UDM GID stored in the UE context. The selected UDM belongs to a UDM pool (the previous UDM GID) which is no longer serving the UE, since the UE has been moved to another UDM pool/GID, i.e. the mapping stored in UDR for UE->GID has changed, but neither NRF nor AMF are aware of it. As a result, a service request may be sent towards incorrect NF Producer, for example, and the UE may need to retry the service request, leading to a long latency and poor user experiences.

As it can be observed, there is no UDR group ID change in any UDM/UDR NF profiles stored in NRF, so there is no notification from NRF that the mapping of the UE->UDM GID has been changed. Actually, there is currently no mechanism to notify about changes in the mapping (provisioned per UE), for example, to let the NF Consumer (e.g., AMF) to know that the UE is now served by a different pool of UDMs. The same may happen for PCF GID mapping, HSS GID mapping, etc., since the mapping provided by UDR (provisioned data for each UE) is actually per UE+NF type->GID (for the requested UE+NF type), whereas the Nudr_GroupIDmap Service in the UDR only provides the query operation.

Techniques for enhanced management of user segment with NF Group ID are provided according to embodiments of the present disclosure. For example, subscribe/notify service operations may be added to the Nudr_GroupIDmap service as specified in 3GPP TS 29.504 V17.8.0. Then, the UDR can provide the NF Consumer/SCP/NRF with notifications about the change in mapping of UE identity to NF group ID in the UDR. The NF Consumer/SCP/NRF can update a previous stored UE identity to NF Group ID mapping with the notification. Then NF Consumer/SCP can utilize the new mapping to perform the discovery to find the correct target NF Producer handling the service request. Otherwise, the NF Consumer/SCP has to perform the discovery with the UE identity to find the correct NF instance for each service request or after the NF Consumer receives the failure response with additional implementation logic.

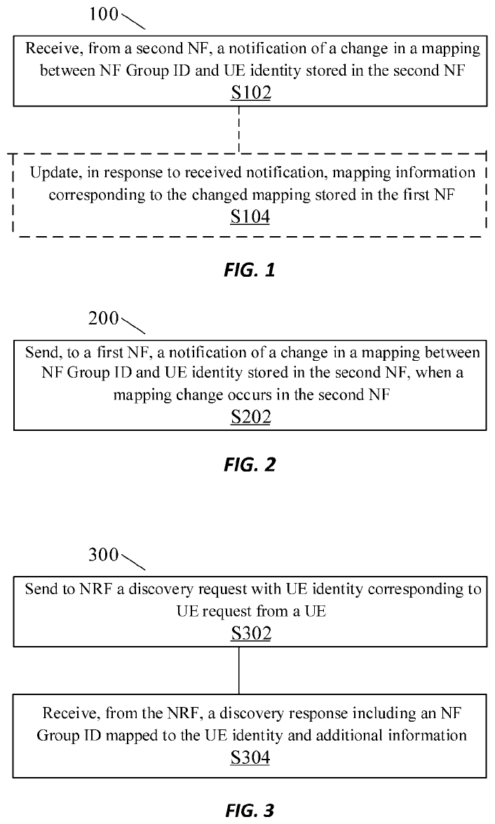

FIGS. 1 and 2 are flowcharts illustrating exemplary methods in a first and second NFs of a communication network (e.g., 5GC) respectively, according to various embodiments of the present disclosure.

With reference to FIG. 1, the method 100 in a first NF may include an operation S102 of receiving, from a second NF, a notification of a change in a mapping between NF Group ID and UE identity stored in the second NF. In this way, the first NF may know the mapping between NF Group ID and UE identity has been changed, and then may inform other NF consumers of the change in the mapping, Additionally or alternatively, the method 100 may further include an operation S104 of updating mapping information stored in the first NF in response to receiving, from a second NF, a notification of a change in a mapping between NF Group ID and UE identity stored in the second NF, as shown in a dashed-line block.

For example, the first NF may include NF consumer, NRF or SCP, and the second NF may include UDR.

In some embodiments, the change may include one or more changes in one or more mappings between NF Group ID and UE identity for one or more NF Types. For example, the UDR may aggregate multiple changes of mapping into one notification.

In some embodiments, the notification may include:
UE identity or list of ranges of UE identities for which the mapping is changed;
NF Group ID for which the mapping is changed; and
NF Type for which the mapping is changed.

In some embodiments, the first NF may send, to the second NF, a subscription request for subscribing the notification of the change in the mapping stored in the second NF. The subscription request may include:
Callback URI where the first NF receives the notification from the second NF;
subscription condition indicating one or more mappings between NF Group ID and UE identity to be monitored for change, with respect to one or more NF types.

The subscription condition may include one or more of:
NF Group ID for which mapping between NF Group ID and UE identity is to be monitored for change;
list of ranges of UE identities whose mapping with NF Group ID is to be monitored for change; and
list of subscription identifiers.

In some embodiments, the subscription request further includes one or more of:
NF instance ID of the first NF;
subscription ID for newly created resource, which is set to be absent in the subscription request; and
validity time indicating a time instance after which the subscription becomes invalid.

Also, for example, the NF Consumer/NRF/SCP may aggregate more mapping between NF Group ID and UE identity for one or more NF Types into one subscription to avoid the huge subscriptions created in the UDR.

In some embodiments, the first NR may receive, from the second NF, a subscription response to the subscription request, wherein the subscription response may include subscription ID for newly created resource. In some embodiments, the subscription response may further include validity time indicating a time instance after which the subscription becomes invalid. With reference to the Subscription ID and validity time, the first NF may perform subscription update, refresh, deletion or the like, for example, if the NF Group ID in the subscribed mapping is changed, or if the validity time has reached.

In some embodiments, the method 100 may further include an operation of sending, to a NRF, a discovery request with a UE identity corresponding to a UE request from a UE, and an operation of receiving, from the NRF, a discovery response including an NF Group ID mapped to the UE identity and additional information. The additional information may indicate a mapping source which provides mapping between the NF Group ID and the UE identity.

In some embodiments, the mapping source may indicate one of:
the NRF if the mapping between the NF Group ID and the UE identity is provided by the NRF locally; and
UDR ID if the mapping between the NF Group ID and the UE identity is provided by a UDR.

In some embodiments, upon receiving the discovery response in which the mapping source indicates a UDR ID of a UDR providing the mapping between the NF Group ID and the UE identity, the first NF may send, to the UDR as the second NF, the subscription request for subscribing the notification of the change in the mapping stored in the UDR, by using the indicated UDR ID.

In some embodiments, if the notification indicates that UE identity is moved to a mapping with another NF Group ID, the first NF may send, to the second NF, another subscription request for subscribing notification of change in the mapping with respect to the other NF Group ID.

With reference to FIG. 2, the method 200 in the second NF may include an operation S202 of sending, to a first NF, a notification of a change in a mapping between NF Group ID and UE identity stored in the second NF, when a mapping change occurs in the second NF.

In some embodiments, the second NF may receive, from the first NF, a subscription request for subscribing the notification of the change in the mapping stored in the second NF, and an operation of sending, to the first NF, a subscription response to the subscription request. The subscription response may include subscription ID for newly created resource. In some embodiments, the subscription response may further include validity time indicating a time instance after which the subscription becomes invalid.

In some embodiments, if the notification indicates that UE identity is moved to a mapping with another NF Group ID, the second NF may receive, from the first NF, another subscription request for subscribing notification of change in the mapping with respect to the other NF Group ID.

FIGS. 3 and 4 are flowcharts illustrating exemplary methods in NF consumer and NRF of a communication network (e.g., 5GC) respectively, according to various embodiments of the present disclosure.

Referring to FIG. 3, the method 300 in a NF consumer may include an operation S302 of sending, to NRF, a discovery request with a UE identity corresponding to a UE request from a UE, and an operation S304 of receiving, from the NRF, a discovery response including an NF Group ID mapped to the UE identity and additional information. The additional information may indicate a mapping source which provides mapping between the NF Group ID and the UE identity.

In some embodiments, the mapping source may indicate one of:
the NRF if the mapping between the NF Group ID and the UE identity is provided by the NRF locally; and
UDR ID if the mapping between the NF Group ID and the UE identity is provided by a UDR.

In some embodiments, upon receiving the discovery response in which the mapping source indicates a UDR ID of a UDR providing the mapping between the NF Group ID and the UE identity, the NF consumer may send, to the UDR, a subscription request for subscribing notification of change in mapping between NF Group ID and UE identity stored in the UDR, by using the indicated UDR ID.

Now with reference to FIG. 4, the method 400 in a NFR, which corresponds to the method 300, may include an operation S402 of receiving, from the NF consumer, a discovery request with a UE identity corresponding to a UE request from a UE, and an operation S404 of sending, to the NF consumer, a discovery response including an NF Group ID mapped to the UE identity and additional information.

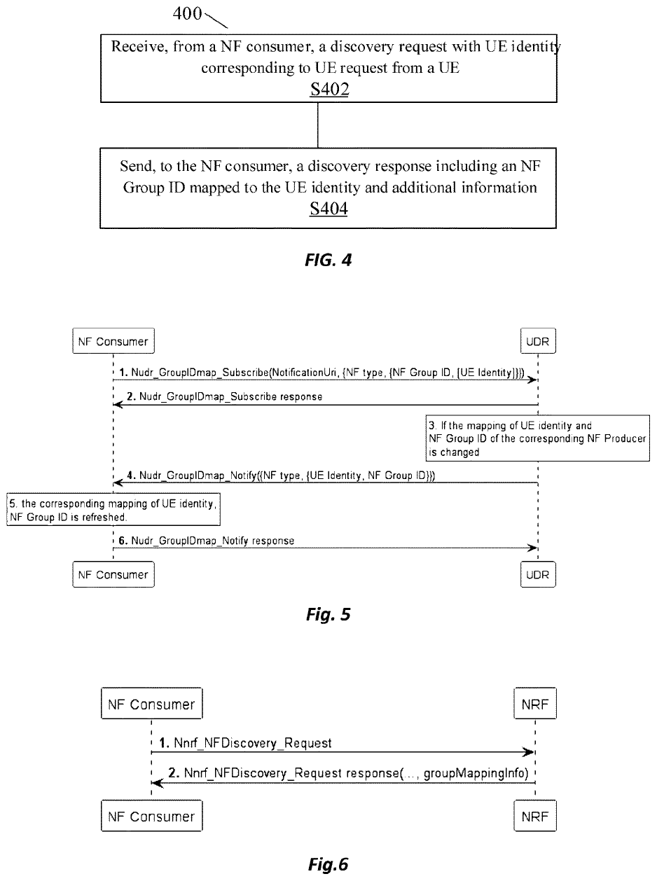

So far, the methods in the NF consumer/SCP, NRF and UDR have been described. In the following, example flows of interactions between them according to various embodiments of the present disclosure will be described in connection with FIGS. 5 to 8B.

FIG. 5 shows a flow of an exemplary subscribe/notify procedure according to various embodiments of the present disclosure. Although FIG. 5 shows the procedure is performed between NF consumer and UDR, it is also applicable to procedures between NRF or SCP and UDR.

As shown in FIG. 5, at step 1 the NF consumer may send to the UDR a subscription request, Nudr_GroupIDmap_Subsribe(NotificationUri, {NF type, {NF Group ID, [UE Identity]}}), for subscribing notification of a change in mapping information stored in the UDR. This subscription request may be also referred to as subscription creation request. More specifically, if mapping is provided by the UDR, the NF consumer may send the subscription request with information elements SubData to the UDR for notification of update of mapping with new introduced service operation. Here, SubData may be defined as follows.

### Type: SubData

TABLE 1
Definition of type SubData

| Attribute name | Data type | P | Cardinality | Description |
|---|---|---|---|---|
| notificationUri | Uri | M | 1 | Callback URI where the NF Service Consumer will |
| | | | | receive the notifications from UDR. |
| reqNfInstanceId | NfInstanceId | O | 0 . . . 1 | If present, this IE shall contain the NF instance id of |
| | | | | the NF service consumer. |
| subscrCond | map(NfGroupIdMap) | O | 0 . . . 1 | This attribute shall contain the conditions identifying |
| | | | | the Mapping of NF Group ID and UE identities to be |
| | | | | monitored. The key of the map is the NF Type of |
| | | | | which the NF Group mapping included in. |
| subscriptionId | string | C | 0 . . . 1 | Subscription ID for the newly created resource. This |
| | | | | parameter shall be absent in the request to the UDR |
| | | | | and shall be included by UDR in the response to the |
| | | | | subscription creation request. |
| | | | | Read-Only: true |
| | | | | Pattern: “\hat{ }{[0-9]{5,6}-)?[\hat{ }-]+$” |
| validityTime | DateTime | C | 0 . . . 1 | Time instant after which the subscription becomes |
| | | | | invalid. This parameter may be sent by the client, as |
| | | | | a hint to the server, but it shall be always sent back |
| | | | | by the server (regardless of the presence of the |
| | | | | attribute in the request) in the response to the |
| | | | | subscription creation request. |

### Type: NfGroupIDMap

TABLE 2
Definition of type NfGroupIDMap

| Attribute name | Data type | P | Cardinality | Description |
|---|---|---|---|---|
| nfGroupIDMap | map(MappingIdentity)) | O | 0 . . . 1 | The mapping of NF Group ID and UE identities the |
| | | | | subscription wants to monitor. |
| | | | | The key of nfGroupMapping is NfGroupId. |

### Type: MappingIdentity

TABLE 3
Definition of type MappingIdentity

| Attribute name | Data type | P | Cardinality | Description |
|---|---|---|---|---|
| supiRanges | array(SupiRange) | O | 0 . . . 1 | List of ranges of SUPI's whose mapping with the NF |
| | | | | Group ID is monitored. |
| subsciberIds | array(subscriberId) | O | 0 . . . 1 | List of Subscription Identifier SUPI or GPSI or IMPI |
| | | | | or IMPU |

Note:
one of supiRanges or subscriberIds shall be present.

At step 2, in response to the subscription request, the UDR may send to the NF consumer a subscription response Nudr_GroupIDmap_Subscribe response that may include Subscription ID and validity time as defined in Table 1. With reference to the Subscription ID and validity time, the NF consumer may perform subscription update, refresh, deletion or the like, for example, if the NF Group ID in the subscribed mapping is changed, or if the validity time has reached.

At step 3, if mapping of UE identity and NF Group ID of the corresponding NF Producer is changed in UDR, for example, due to O&M by the operator, the UDR may update the mapping information. Then, at step 4, the UDR may send a notification of the mapping change to the NF consumer. The notification may be in a form of Nudr_GroupIDmap_Notify({NF type, {UE Identity, NF Group ID}}). The information elements NfGroupIdMapNotificaiton included in the notification may be defined as follows.

### Type: NfGroupIdMapNotificaiton

TABLE 4
Definition of type NfGroupIdMapNotificaiton

| Attribute name | Data type | P | Cardinality | Description |
|---|---|---|---|---|
| nfGroupIDMappingChanges | map(NfGroupIDMap) | O | 0 . . . 1 | This attribute shall contain the conditions identifying |
| | | | | the Mapping of NF Group ID and UE identities to be |
| | | | | monitored. The key of the map is the NF Type of |
| | | | | which the NF Group mapping is changed. |

At step 5, upon receiving the notification of mapping change from the UDR, the NF consumer may refresh/update the corresponding mapping information of UE identity and NF Group ID locally stored in the NF consumer.

Optionally, the NF consumer may send a notification response to the UDR at step 6. For example, the notification response may inform the UDR that the notification of the mapping change has been successfully/unsuccessfully received. In another example, the notification response may inform that the mapping update has completed at step 5.

In this way, the subscribe/notify operation may be introduced into the Nudr_GroupIDmap service, so the SCP/NRF/NF Consumer can be notified about the mapping change happened in the UDR and updates the corresponding context.

Please be noted that the NF Consumer/NRF/SCP may aggregate more than one mapping between NF Group ID and UE identity for one or more NF Types into one subscription to avoid huge subscriptions created in the UDR. Also, the UDR may aggregate multiple changes of mapping into one notification to reduce signalling overhead.

FIG. 6 shows a flow of an exemplary discovery procedure between NF consumer and the NRF according to various embodiments of the present disclosure. Different from the conventional discovery procedure in which the NRF return only NF Group ID only in the discovery response if the mapping of UE identities and NF Group ID is provided by the UDR, the NRF may include additional information in the discovery response to let the NF consumer to know the mapping source that provides the mapping information. Specifically, as shown in FIG. 6, at step 1, the NF consumer may send a discovery request Nnrf_NFDiscovery_Request to the NRF with UE identity corresponding to a request from a UE. Then, at step 2, the NRF may send a discovery response Nnrf_NFDiscovery_Request response ( . . . , groupMappingInfo) to the NF consumer, that includes NF Group ID in the NFProfile of NF Instances as well as additional information groupMappingInfo indicating e.g., the corresponding UDR Instance as the source providing the mapping information. The additional information groupMappingInfo may be added and defined in SearchResult in 3GPP TS 29.510 V17.7.0, clause 6.2.6.2.2.

### Type: SearchResult

TABLE 6.2.6.2.2-1
Definition of type SearchResult

| Attribute name | Data type | P | Cardinality | Description |
|---|---|---|---|---|
| . . . | . . . | . . . | . . . | . . . |
| groupMappingInfo | Map(GroupIdMappingInfo) | O | 0 . . . 1 | It shall be present if only NF Group ID is provided in |
| | | | | the NFProfile of nfInstances, so the NF Service |
| | | | | Consumer is aware the source of mapping provided. |
| | | | | The key of this map is NfGroupID. |

### Type: GroupIdMappingInfo

TABLE 5
Definition of type GroupIdMappingInfo

| Attribute name | Data type | P | Cardinality | Description |
|---|---|---|---|---|
| mappingSource | MappingSource | M | 0 . . . 1 | It shall be present if only NF Group ID is provided in |
| | | | | the NFProfile of nfInstances, so the NF Service |
| | | | | Consumer is aware the source of mapping provided. |
| | | | | The key of this map is NfGroupID. |
| udrInstance | NfInstanceId | O | 0 . . . 1 | It shall be present if the mapping of NF Group ID and |
| | | | | UE identity is provided by the UDR. |

TABLE 6
Definition of type MappingSource
Enumeration: MappingSource

| Enumeration value | Description |
|---|---|
| “NRF_LOCAL” | The mapping of NF Group ID and UE |
| | identity is provided by the NRF locally. |
| “UDR” | The mapping of NF Group ID and UE |
| | Identity is provided by the UDR. |

By including such additional information in NF discovery response from the NRF to the NF consumer, the NF Consumer may know the mapping of the UE Identity and the NF Group ID is provided by the UDR and the corresponding UDR instance. This may allow the NF Consumer to subscribe the notification of mapping change introduced as above in FIG. 5. Accordingly, the NF Consumer can know the mapping change towards the UE Identity and apply the corresponding updates.

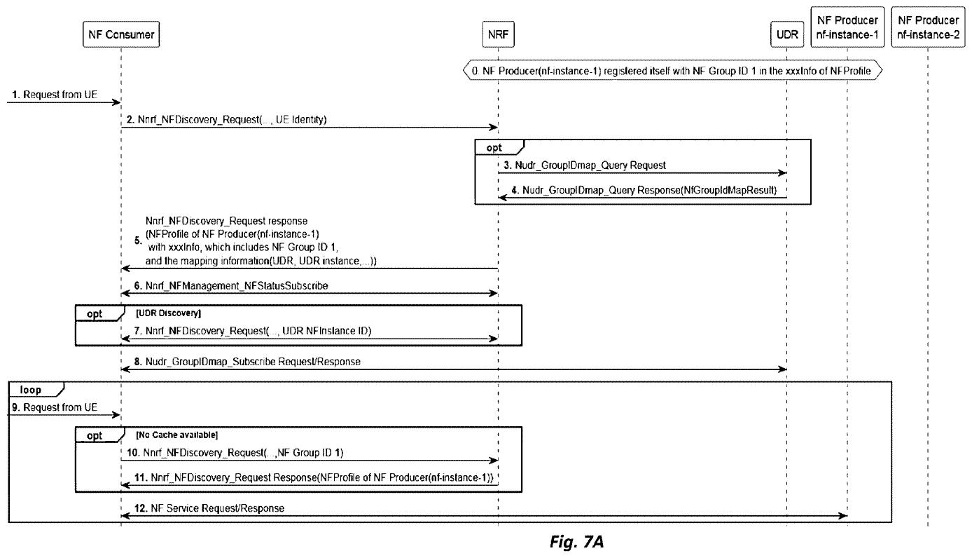

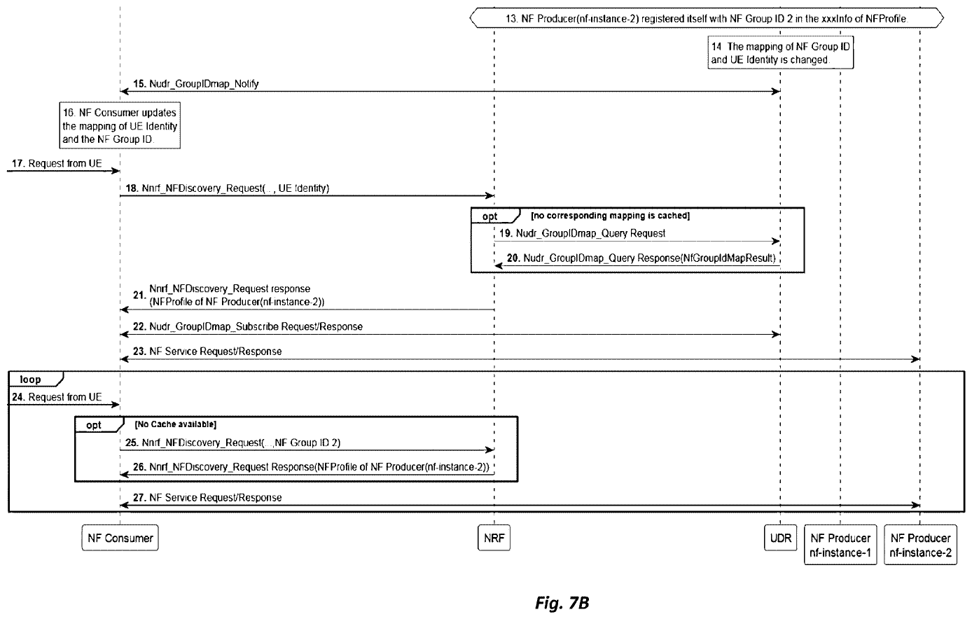

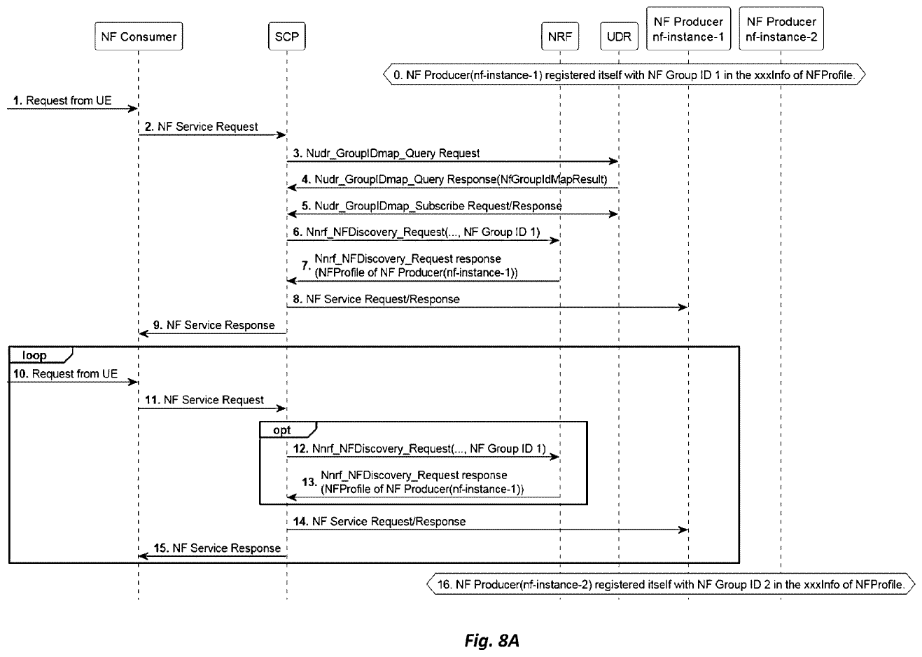

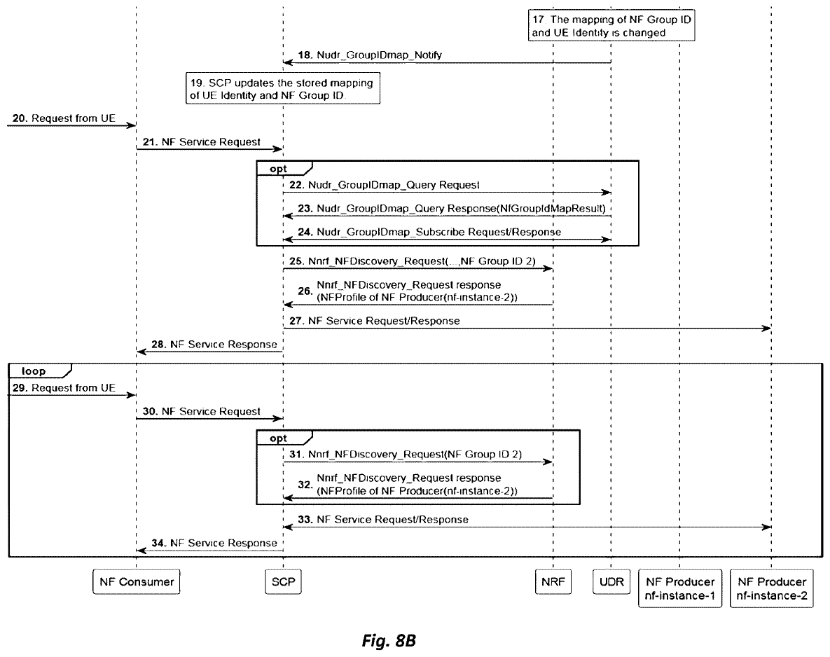

More details will be given with reference to FIGS. 7A to 8B which depict two different scenarios, which may be separated into:
Direct Communication between NF consumer, NRF and UDR according to various embodiments of the present disclosure, where mapping of UE identity ranges and NF Group ID is provided by the UDR; please be noted that this is also applicable to indirect communication without delegate discovery, which is similar with the scenarios of Direct Communication and thus not described in the diagram.
Indirect Communication between NF consumer, SCP, NRF and UDR according to various embodiments of the present disclosure, where Delegate Discovery with SCP is included. Also, the mapping of UE identity ranges and NF Group ID is provided by the UDR.

The prerequisite for these diagrams are that the NF Producer (nf-instance-1) registers itself with NF Group ID 1 in the NRF (as step 0), and mapping of UE Identity and NF Group ID is provided by the UDR. Scenario 1 of direct communication will be described first by referring to FIGS. 7A and 7B.

### Scenario 1: Direct Communication

At step 1, the NF Consumer receives a request from a UE.

At step 2, the NF Consumer performs a discovery for NF Producer via the NRF by sending Nnrf_NFDiscovery_Request with a UE identity (e.g. SUPI) corresponding to the received UE request as the query factor.

At step 3, the NRF retrieves, from the UDR, the NF Group ID mapping for the requested UE and the corresponding NF Type.

At step 4, the UDR responses, to the NRF, the provisioning NF Group ID according to the input UE identity and the NF Type.

At step 5, the NRF returns the NFProfile of NF Producer (nf-instance-1) to the NF consumer, which includes the NF Group ID 1 corresponding to the NF Producer (nf-instance-1). The NRF also provides additional information to the NF Consumer about the repository of the mapping of UE Identity and NF Group ID from the UDR. The corresponding UDR instance (e.g., UDR ID) is included as well. The inclusion of additional information has been described above in connection with FIG. 6. Please be noted that this is applicable to the following discovery response to the NF Consumer.

At step 6, the NF Consumer subscribes, with the NFR, the change on the NFProfile of NF Producer (nf-instance-1).

At step 7, the NF Consumer performs a discovery according to the UDR instance returned from Step 5 to find the UDR instance providing the mapping of UE identity and NF Group ID.

At step 8, the NF Consumer subscribes, with the UDR, notification of change in the mapping information stored in the UDR, with respect to NF Group ID 1. The subscription has been described above in connection with FIG. 5.

Then, the NF Consumer continues to handle subsequent requests. At step 9, the NF Consumer receives a subsequent request from the UE.

At step 10, the NF Consumer sends the Nnrf_NFDiscovery_Request message to the NRF with the NF Group ID, i.e. NF Group ID 1.

At step 11, the NRF responses to the NF Consumer with the NFProfile of the target NF Producer (nf-instance-1).

If there is cache of the NFProfile of the target NF Producer (nf-instance-1) available locally in the NF consumer, steps 10 and 11 may be skipped.

At step 12, the NF Consumer selects the target NF Producer (nf-instance-1) based on the discovery result and sends the Service Request to the NF Producer (nf-instance-1), and then receives the service response from the NF Producer (nf-instance-1).

At step 13, the operator updates the network deployment by adding a new same type of NF Producer (nf-instance-2) with NF Group ID 2, to which the UE identity is newly mapped instead of the previous NF Group ID 1.

At step 14, the provisioned mapping information in the UDR is updated, in order to provide the new mapping of UE Identity and NF Group ID for the subsequent requests from the NRF.

At step 15, as the NF Consumer has subscribed, with the UDR, notification of change in the mapping information stored in the UDR at step 8, the UDR notifies the mapping change to the NF Consumer via Nudr_GroupIDmap Notify about that the UE identity is removed from the previously subscribed NF Group ID 1 to the NF Group ID 2.

At step 16, upon receiving the notification, the NF Consumer updates its mapping of UE Identity and NF Group ID according to information elements included in the notification.

Then, at step 17, a new request is received by the NF Consumer from the UE.

At step 18, the NF Consumer sends a new discovery request still with the UE Identity to the NRF if there is no subscription to the UDR to know new NF Group ID (i.e., NF Group ID 2) to which the UE is moved to.

At step 19, the NRF retrieves from the UDR the NF Group ID mapping for the requested UE and the corresponding NF type.

At step 20, the UDR responses to the NRF the provisioning NF Group ID according to the input UE identity and NF type.

Here, if there is corresponding mapping information cached in the NRF either by the synchronization by the subscribe/notify operation between the NRF and the UDR (as described with reference to FIG. 5), or by local cache, steps 19 and 20 may be skipped.

At step 21, the NRF returns, to the NF Consumer, the NFProfile of the NF Producer (nf-instance-2), which includes the NF Group ID 2 in the NFProfile.

At step 22, the NF Consumer subscribes, with the UDR, notification of change in the mapping information of the new NF Group ID, i.e. NF Group ID 2 in the UDR.

At step 23, the NF Consumer sends service request to the NF Producer (nf-instance-2) based on the discovery result, instead of the previous NF Producer (nf-instance-1, which has NF Group ID 1.

After that, at steps 24 to 27, the NF Consumer uses NF Group ID 2 to find the target NF Producer (nf-instance-2) for the corresponding UE, and communicate with the target NF Producer (nf-instance-2). Steps 24 to 27 are similar to steps 9 to 12, except that NF Group ID 1 is changed to NF Group ID 2, and the NF Producer (nf-instance-1) is replaced with the NF Producer (nf-instance-2).

Now, Scenario 2 of indirect communication with delegate discovery will be described first by referring to FIGS. 8A and 8B.

Scenario 2: Indirect Communication with Delegate Discovery

At step 1, the NF Consumer receives a request from a UE.

At step 2, the NF Consumer sends, to SCP, a Service Request with UE identity corresponding to the UE request.

At step 3, the SCP queries mapping of NF Group ID and UE identity from the UDR based on the UE identity received in the Service Request.

At step 4, the UDR returns, to the SCP, mapping information corresponding to the UE identity.

At step 5, at the same time or upon receiving the mapping information, the SCP subscribes, with the UDR, notification of change in the mapping information in the UDR, with respect to the current NF Group ID (i.e., NF Group ID 1). This may be similar to the subscription described above with reference to FIG. 5.

At step 6, the SCP performs a discovery to find the target NF Producer with the NF Group ID mapped from the UE identity, i.e. NF Group ID 1.

At step 7, the NRF returns, to the SCP, the NFProfile of the target NF Producer (nf-instance-1).

At step 8, the SCP forwards the Service Request towards the target NF Producer (nf-instance-1). The target NF Producer (nf-instance-1) handles the service request, and sends a service response to the SCP.

At step 9, the SCP forwards the service response to the NF Consumer which initiates the Service Request.

Then, the NF Consumer continues to handle subsequent requests from the UE. At step 10, a subsequent request is received by the NF Consumer from the UE.

At step 11, the NF Consumer sends the Service Request to the SCP.

Here, if there is no corresponding information for the target NF producer (nf-instance-1) existing in the cache of SCP, the SCP performs a discovery for the target NF Producer at steps 12 and 13. Otherwise, if there is corresponding information for the target NF producer (nf-instance-1) cached in SCP, the steps 12 and 13 may be skipped.

At step 12, the SCP sends a discovery request to the NRF for the target NF Producer with the NF Group ID, i.e. NF Group ID 1.

At step 13, the NRF returns the NFProfile of the NF Producer (nf-instance-1) to the SCP.

At step 14, the SCP forwards the Service Request towards the target NF Producer (nf-instance-1). Then the target NF Producer (nf-instance-1) handles the service request and sends a service response.

At step 15, the SCP forwards the service response to the NF Consumer which initiates the Service Request.

At step 16, the operator updates the network deployment by adding a new same type of NF Producer (nf-instance-2) with NF Group ID 2, to which the UE identity is newly mapped instead of the previous NF Group ID 1.

At step 17, the provisioned mapping information in the UDR is updated as well.

At step 18, as the SCP has subscribed, with the UDR, notification of change in the mapping information stored in the UDR at step 5, the UDR notifies the mapping change to the SCP via Nudr_GroupIDmap_Notify.

At step 19, the SCP updates the mapping of UE Identity and NF Group ID according to the notification from the UDR.

At step 20, a subsequent request is received by the NF consumer from the UE.

At step 21, the NF Consumer sends a subsequent service request to the SCP.

If there is no subscription to the UDR to know the new NF Group ID (i.e., NF Group ID 2) the UE is moved to, steps 22-24 are performed.

At step 22, the SCP queries mapping information of NF Group ID and the UE identity from the UDR based on the UE identity received in the subsequent Service Request.

At step 23, the UDR returns, to the SCP, mapping information corresponding to the UE identity.

At step 24, at the same time or upon receiving the mapping information, the SCP subscribes notification of change in the mapping information in the UDR, with respect to the new NF Group ID (i.e., NF Group ID 2).

At step 25, the SCP sends a discovery request to the NRF for the target NF Producer with the new NF Group ID (i.e., NF Group ID 2) returned from step 23.

At step 26, the NRF returns, to the SCP, the NFProfile of the NF Producer (nf-instance-2).

At step 27, the SCP forwards the Service Request towards the target NF Producer. The target NF Producer handles the service request, and sends a service response.

At step 28, the SCP forwards the service response to the NF Consumer which initiates the Service Request.

After that, at steps 29 to 34, the SCP uses NF Group ID 2 to forward the target NF Producer for the corresponding UE, and communicate with the target NF producer (nf-instance-2). Steps 29 to 34 are similar to steps 10 to 15, except that NF Group ID 1 is changed to NF Group ID 2, and the NF Producer (nf-instance-1) is replaced with the NF Producer (nf-instance-2).

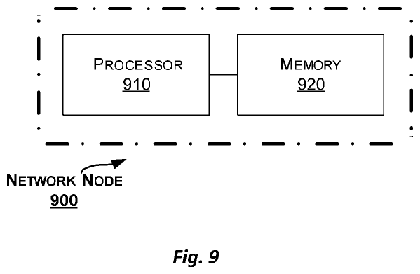

FIG. 9 is a schematic block diagram of a network node implementing a NF of a communication network (e.g., 5GC) according to various embodiments of the present disclosure. The network node 900 includes a processor 910 and a memory 920 coupled to the processor 910. The memory 920 may contain instructions executable by the processor 910 whereby the network node 900 is operative to, when implementing a first NF (e.g., NF consumer, SCP, or NRF), perform the operations, e.g., of the procedure described earlier in conjunction with FIGS. 1 and 5. Particularly, the memory 920 may contain instructions executable by the processor 910 whereby the network node 900 implementing the first NF is operative to receive, from a second NF (e.g., UDR), a notification of a change in a mapping between NF Group ID and UE identity stored in the second NF.

Alternatively, the memory 920 may contain instructions executable by the processor 910 whereby the network node 900 is operative to, when implementing a second NF (e.g., UDR), perform the operations, e.g., of the procedure described earlier in conjunction with FIGS. 2 and 5. Particularly, the memory 920 may contain instructions executable by the processor 910 whereby the network node 900 implementing the second NF is operative to send, to the first NF, a notification of a change in a mapping between NF Group ID and UE identity stored in the second NF, when a mapping change occurs in the second NF.

Alternatively, the memory 920 may contain instructions executable by the processor 910 whereby the network node 900 is operative to, when implementing a NF consumer, perform the operations, e.g., of the procedure described earlier in conjunction with FIGS. 3 and 6. Particularly, the memory 920 may contain instructions executable by the processor 910 whereby the network node 900 implementing the NF consumer is operative to send, to NRF, a discovery request with a UE identity corresponding to a UE request from a UE; and receive, from the NRF, a discovery response including an NF Group ID mapped to the UE identity and additional information. The additional information indicates a mapping source which provides mapping between the NF Group ID and the UE identity.

Alternatively, the memory 920 may contain instructions executable by the processor 910 whereby the network node 900 is operative to, when implementing a NRF, perform the operations, e.g., of the procedure described earlier in conjunction with FIGS. 4 and 6. Particularly, the memory 920 may contain instructions executable by the processor 910 whereby the network node 900 implementing the NRF is operative to receive, from the NF consumer, a discovery request with a UE identity corresponding to a UE request from a UE; and send, to the NF consumer, a discovery response including an NF Group ID mapped to the UE identity and additional information. The additional information indicates a mapping source which provides mapping between the NF Group ID and the UE identity.

The processor 910 may be a single CPU (Central Processing Unit), but could also comprise two or more processing units. For example, the processor may include general purpose microprocessors; instruction set processors and/or related chips sets and/or special purpose microprocessors such as Application Specific Integrated Circuits (ASICs). The processor may also comprise board memory for caching purposes.

The present disclosure also provides at least one computer program product in the form of a non-volatile or volatile memory, e.g., a non-transitory computer-readable storage medium, an Electrically Erasable Programmable Read-Only Memory (EEPROM), a flash memory and a hard drive. The computer program product also includes a computer program. The computer program includes: code/computer-readable instructions, which when executed by the processor 910 causes the network node 900 to perform the operations, e.g., of the procedures described earlier in conjunction with FIGS. 1 to 8B.

The above computer program may be contained in a medium, for example, a carrier, which may be one of an electronic signal, optical signal, radio signal, or computer-readable medium.

So far, various embodiments have been described. With the proposed solutions, when the mapping of UE identity and NF Group ID is changed in the UDR, the NF Consumer/SCP/NRF can receive the notification of the mapping change, apply the corresponding update on the mapping information, and utilize the updated mapping of UE identity and NF Group ID for the discovery, which is not possible with the current 3GPP specification. Besides, the NF Consumer can send NF service request towards the correct NF Producer directly, i.e., not need to retry the NF service request with
An additional discovery with UE Identity to the NRF, and then to the UDR if there is no corresponding notification of new mapping;
Additional failure handling based on the application error responded from the NF producer which served the UE before the change.

In general, with the proposed solutions, the corresponding use case can be supported, and UE experiences can be improved, for example, the latency of the procedure (general registration, or handover procedure intra 5GC) will not be increased.

Although various embodiments are described herein above in terms of methods, apparatus, devices, computer-readable medium and receivers, the person of ordinary skill will readily comprehend that such methods can be embodied by various combinations of hardware and software in various systems, communication devices, computing devices, control devices, apparatuses, non-transitory computer-readable media, etc.

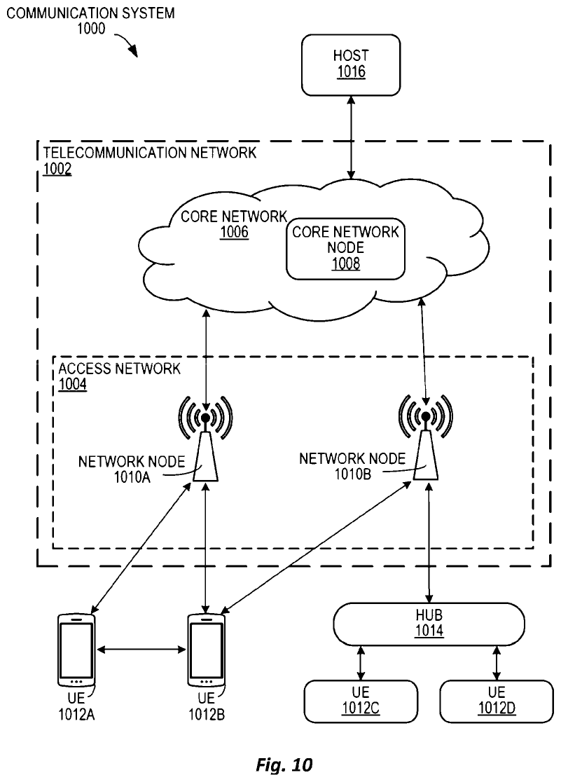

FIG. 10 shows an example of a communication system 1000 in accordance with some embodiments. The concept of the present disclosure may be applied in the communication system 1000. In this example, the communication system 1000 includes a telecommunication network 1002 that includes an access network 1004, such as a radio access network (RAN), and a core network 1006, which includes one or more core network nodes 1008. The access network 1004 includes one or more access network nodes, such as network nodes 1010a and 1010b (one or more of which may be generally referred to as network nodes 1010), or any other similar 3^{rd} Generation Partnership Project (3GPP) access node or non-3GPP access point. The network nodes 1010 facilitate direct or indirect connection of user equipment (UE), such as by connecting UEs 1012a, 1012b, 1012c, and 1012d (one or more of which may be generally referred to as UEs 1012) to the core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the network nodes 1010 are arranged, capable, configured, and/or operable to communicate directly or indirectly with the UEs 1012 and/or with other network nodes or equipment in the telecommunication network 1002 to enable and/or provide network access, such as wireless network access, and/or to perform other functions, such as administration in the telecommunication network 1002.

In the depicted example, the core network 1006 connects the network nodes 1010 to one or more hosts, such as host 1016. These connections may be direct or indirect via one or more intermediary networks or devices. In other examples, network nodes may be directly coupled to hosts. The core network 1006 includes one more core network nodes (e.g., core network node 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF). The SMF and AMF as well as methods in them according to various embodiments of the present disclosure may be implemented in the core network nodes.

The host 1016 may be under the ownership or control of a service provider other than an operator or provider of the access network 1004 and/or the telecommunication network 1002, and may be operated by the service provider or on behalf of the service provider. The host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

In various embodiments, core network node 1008 can implement network function (NF) of communication system or network 900. In other words, the NF may be located in the core network 1006 or coupled to the core network 1006. Such a NF can be configured to perform operations corresponding to exemplary methods described above.

As a whole, the communication system 1000 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1002 is a cellular network that implements 3GPP standardized features. Accordingly, the telecommunications network 1002 may support network slicing to provide different logical networks to different devices that are connected to the telecommunication network 1002. For example, the telecommunications network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 1014 communicates with the access network 1004 to facilitate indirect communication between one or more UEs (e.g., UE 1012c and/or 1012d) and network nodes (e.g., network node 1010b). In some examples, the hub 1014 may be a controller, router, content source and analytics, or any of the other communication devices described herein regarding UEs. For example, the hub 1014 may be a broadband router enabling access to the core network 1006 for the UEs. As another example, the hub 1014 may be a controller that sends commands or instructions to one or more actuators in the UEs. Commands or instructions may be received from the UEs, network nodes 1010, or by executable code, script, process, or other instructions in the hub 1014. As another example, the hub 1014 may be a data collector that acts as temporary storage for UE data and, in some embodiments, may perform analysis or other processing of the data. As another example, the hub 1014 may be a content source. For example, for a UE that is a VR headset, display, loudspeaker or other media delivery device, the hub 1014 may retrieve VR assets, video, audio, or other media or data related to sensory information via a network node, which the hub 1014 then provides to the UE either directly, after performing local processing, and/or after adding additional local content. In still another example, the hub 1014 acts as a proxy server or orchestrator for the UEs, in particular in if one or more of the UEs are low energy IoT devices.

The hub 1014 may have a constant/persistent or intermittent connection to the network node 1010b. The hub 1014 may also allow for a different communication scheme and/or schedule between the hub 1014 and UEs (e.g., UE 1012c and/or 1012d), and between the hub 1014 and the core network 1006. In other examples, the hub 1014 is connected to the core network 1006 and/or one or more UEs via a wired connection. Moreover, the hub 1014 may be configured to connect to an M2M service provider over the access network 1004 and/or to another UE over a direct connection. In some scenarios, UEs may establish a wireless connection with the network nodes 1010 while still connected via the hub 1014 via a wired or wireless connection. In some embodiments, the hub 1014 may be a dedicated hub—that is, a hub whose primary function is to route communications to/from the UEs from/to the network node 1010b. In other embodiments, the hub 1014 may be a non-dedicated hub—that is, a device which is capable of operating to route communications between the UEs and network node 1010b, but which is additionally capable of operating as a communication start and/or end point for certain data channels.

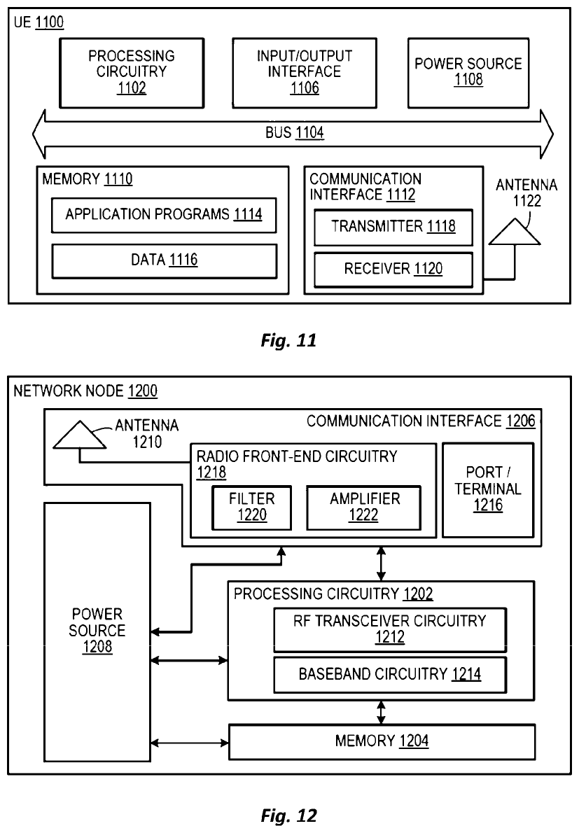

FIG. 11 shows a UE 1100 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1100 includes processing circuitry 1102 that is operatively coupled via a bus 1104 to an input/output interface 1106, a power source 1108, a memory 1110, a communication interface 1112, and/or any other component, or any combination thereof. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

The processing circuitry 1102 is configured to process instructions and data and may be configured to implement any sequential state machine operative to execute instructions stored as machine-readable computer programs in the memory 1110. The processing circuitry 1102 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1102 may include multiple central processing units (CPUs).

In the example, the input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1108 is structured as a battery or battery pack. Other types of power sources, such as an external power source (e.g., an electricity outlet), photovoltaic device, or power cell, may be used. The power source 1108 may further include power circuitry for delivering power from the power source 1108 itself, and/or an external power source, to the various parts of the UE 1100 via input circuitry or an interface such as an electrical power cable. Delivering power may be, for example, for charging of the power source 1108. Power circuitry may perform any formatting, converting, or other modification to the power from the power source 1108 to make the power suitable for the respective components of the UE 1100 to which power is supplied.

The memory 1110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1110 includes one or more application programs 1114, such as an operating system, web browser application, a widget, gadget engine, or other application, and corresponding data 1116. The memory 1110 may store, for use by the UE 1100, any of a variety of various operating systems or combinations of operating systems.

The memory 1110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1110 may allow the UE 1100 to access instructions, application programs and the like, stored on transitory or non-transitory memory media, to off-load data, or to upload data. An article of manufacture, such as one utilizing a communication system may be tangibly embodied as or in the memory 1110, which may be or comprise a device-readable storage medium.

The processing circuitry 1102 may be configured to communicate with an access network or other network using the communication interface 1112. The communication interface 1112 may comprise one or more communication subsystems and may include or be communicatively coupled to an antenna 1122. The communication interface 1112 may include one or more transceivers used to communicate, such as by communicating with one or more remote transceivers of another device capable of wireless communication (e.g., another UE or a network node in an access network). Each transceiver may include a transmitter 1118 and/or a receiver 1120 appropriate to provide network communications (e.g., optical, electrical, frequency allocations, and so forth). Moreover, the transmitter 1118 and receiver 1120 may be coupled to one or more antennas (e.g., antenna 1122) and may share circuit components, software or firmware, or alternatively be implemented separately.

In the illustrated embodiment, communication functions of the communication interface 1112 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1112, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1100 shown in FIG. 11.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 12 shows a network node 1200 in accordance with some embodiments. The RAN node of the present disclosure may be implemented with the network node 1200. The network node may refer to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1200 includes a processing circuitry 1202, a memory 1204, a communication interface 1206, and a power source 1208. The network node 1200 may be composed of multiple physically separate components (e.g., a NodeB component and a RNC component, or a BTS component and a BSC component, etc.), which may each have their own respective components. In certain scenarios in which the network node 1200 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1200 may be configured to support multiple radio access technologies (RATs). In such embodiments, some components may be duplicated (e.g., separate memory 1204 for different RATs) and some components may be reused (e.g., a same antenna 1210 may be shared by different RATs). The network node 1200 may also include multiple sets of the various illustrated components for different wireless technologies integrated into network node 1200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1200.

The processing circuitry 1202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1200 components, such as the memory 1204, to provide network node 1200 functionality.

In some embodiments, the processing circuitry 1202 includes a system on a chip (SOC). In some embodiments, the processing circuitry 1202 includes one or more of radio frequency (RF) transceiver circuitry 1212 and baseband processing circuitry 1214. In some embodiments, the radio frequency (RF) transceiver circuitry 1212 and the baseband processing circuitry 1214 may be on separate chips (or sets of chips), boards, or units, such as radio units and digital units. In alternative embodiments, part or all of RF transceiver circuitry 1212 and baseband processing circuitry 1214 may be on the same chip or set of chips, boards, or units.

The memory 1204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1202. The memory 1204 may store any suitable instructions, data, or information, including a computer program, software, an application including one or more of logic, rules, code, tables, and/or other instructions capable of being executed by the processing circuitry 1202 and utilized by the network node 1200. The memory 1204 may be used to store any calculations made by the processing circuitry 1202 and/or any data received via the communication interface 1206. In some embodiments, the processing circuitry 1202 and memory 1204 is integrated.

The communication interface 1206 is used in wired or wireless communication of signaling and/or data between a network node, access network, and/or UE. As illustrated, the communication interface 1206 comprises port(s)/terminal(s) 1216 to send and receive data, for example to and from a network over a wired connection. The communication interface 1206 also includes radio front-end circuitry 1218 that may be coupled to, or in certain embodiments a part of, the antenna 1210. Radio front-end circuitry 1218 comprises filters 1220 and amplifiers 1222. The radio front-end circuitry 1218 may be connected to an antenna 1210 and processing circuitry 1202. The radio front-end circuitry may be configured to condition signals communicated between antenna 1210 and processing circuitry 1202. The radio front-end circuitry 1218 may receive digital data that is to be sent out to other network nodes or UEs via a wireless connection. The radio front-end circuitry 1218 may convert the digital data into a radio signal having the appropriate channel and bandwidth parameters using a combination of filters 1220 and/or amplifiers 1222. The radio signal may then be transmitted via the antenna 1210. Similarly, when receiving data, the antenna 1210 may collect radio signals which are then converted into digital data by the radio front-end circuitry 1218. The digital data may be passed to the processing circuitry 1202. In other embodiments, the communication interface may comprise different components and/or different combinations of components.

In certain alternative embodiments, the network node 1200 does not include separate radio front-end circuitry 1218, instead, the processing circuitry 1202 includes radio front-end circuitry and is connected to the antenna 1210. Similarly, in some embodiments, all or some of the RF transceiver circuitry 1212 is part of the communication interface 1206. In still other embodiments, the communication interface 1206 includes one or more ports or terminals 1216, the radio front-end circuitry 1218, and the RF transceiver circuitry 1212, as part of a radio unit (not shown), and the communication interface 1206 communicates with the baseband processing circuitry 1214, which is part of a digital unit (not shown).

The antenna 1210 may include one or more antennas, or antenna arrays, configured to send and/or receive wireless signals. The antenna 1210 may be coupled to the radio front-end circuitry 1218 and may be any type of antenna capable of transmitting and receiving data and/or signals wirelessly. In certain embodiments, the antenna 1210 is separate from the network node 1200 and connectable to the network node 1200 through an interface or port.

The antenna 1210, communication interface 1206, and/or the processing circuitry 1202 may be configured to perform any receiving operations and/or certain obtaining operations described herein as being performed by the network node. Any information, data and/or signals may be received from a UE, another network node and/or any other network equipment. Similarly, the antenna 1210, the communication interface 1206, and/or the processing circuitry 1202 may be configured to perform any transmitting operations described herein as being performed by the network node. Any information, data and/or signals may be transmitted to a UE, another network node and/or any other network equipment.

The power source 1208 provides power to the various components of network node 1200 in a form suitable for the respective components (e.g., at a voltage and current level needed for each respective component). The power source 1208 may further comprise, or be coupled to, power management circuitry to supply the components of the network node 1200 with power for performing the functionality described herein. For example, the network node 1200 may be connectable to an external power source (e.g., the power grid, an electricity outlet) via an input circuitry or interface such as an electrical cable, whereby the external power source supplies power to power circuitry of the power source 1208. As a further example, the power source 1208 may comprise a source of power in the form of a battery or battery pack which is connected to, or integrated in, power circuitry. The battery may provide backup power should the external power source fail.

Embodiments of the network node 1200 may include additional components beyond those shown in FIG. 12 for providing certain aspects of the network node's functionality, including any of the functionality described herein and/or any functionality necessary to support the subject matter described herein. For example, the network node 1200 may include user interface equipment to allow input of information into the network node 1200 and to allow output of information from the network node 1200. This may allow a user to perform diagnostic, maintenance, repair, and other administrative functions for the network node 1200.

In various embodiments, network node 1200 can be configured to perform operations performed by network nodes, network functions (NFs), and application functions (AFs) in exemplary methods or procedures described above.

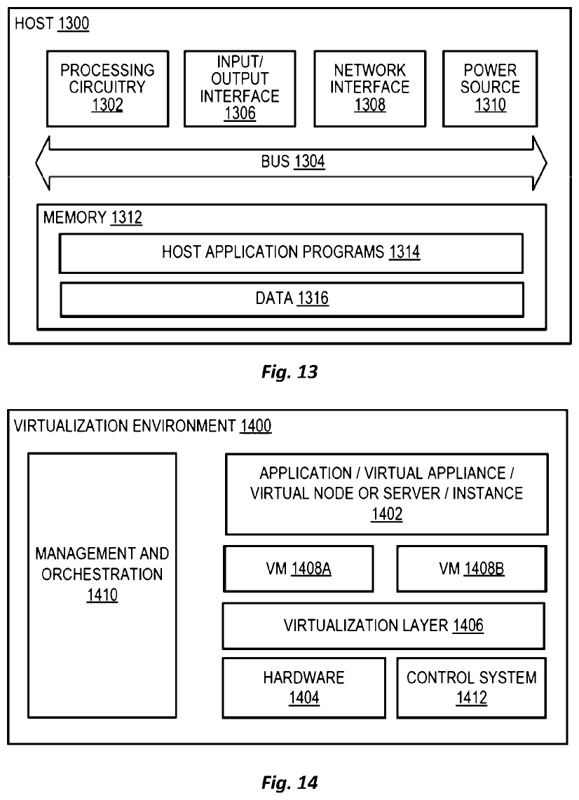

FIG. 13 is a block diagram of a host 1300, which may be an embodiment of the host 1016 of FIG. 10, in accordance with various aspects described herein. As used herein, the host 1300 may be or comprise various combinations hardware and/or software, including a standalone server, a blade server, a cloud-implemented server, a distributed server, a virtual machine, container, or processing resources in a server farm. The host 1300 may provide one or more services to one or more UEs.

The host 1300 includes processing circuitry 1302 that is operatively coupled via a bus 1304 to an input/output interface 1306, a network interface 1308, a power source 1310, and a memory 1312. Other components may be included in other embodiments. Features of these components may be substantially similar to those described with respect to the devices of previous figures, such as FIGS. 11 and 12, such that the descriptions thereof are generally applicable to the corresponding components of host 1300.

The memory 1312 may include one or more computer programs including one or more host application programs 1314 and data 1316, which may include user data, e.g., data generated by a UE for the host 1300 or data generated by the host 1300 for a UE. Embodiments of the host 1300 may utilize only a subset or all of the components shown. The host application programs 1314 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1314 may also provide for user authentication and licensing checks and may periodically report health, routes, and content availability to a central node, such as a device in or on the edge of a core network. Accordingly, the host 1300 may select and/or indicate a different host for over-the-top services for a UE. The host application programs 1314 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 14 is a block diagram illustrating a virtualization environment 1400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1402 (which may alternatively be called software instances, virtual appliances, network functions, virtual nodes, virtual network functions, etc.) are run in the virtualization environment 1400 to implement some of the features, functions, and/or benefits of some of the embodiments disclosed herein.

Hardware 1404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1406 (also referred to as hypervisors or virtual machine monitors (VMMs)), provide VMs 1408a and 1408b (one or more of which may be generally referred to as VMs 1408), and/or perform any of the functions, features and/or benefits described in relation with some embodiments described herein. The virtualization layer 1406 may present a virtual operating platform that appears like networking hardware to the VMs 1408.

The VMs 1408 comprise virtual processing, virtual memory, virtual networking or interface and virtual storage, and may be run by a corresponding virtualization layer 1406. Different embodiments of the instance of a virtual appliance 1402 may be implemented on one or more of VMs 1408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1408 may be a software implementation of a physical machine that runs programs as if they were executing on a physical, non-virtualized machine. Each of the VMs 1408, and that part of hardware 1404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1408 on top of the hardware 1404 and corresponds to the application 1402.

Hardware 1404 may be implemented in a standalone network node with generic or specific components. Hardware 1404 may implement some functions via virtualization. Alternatively, hardware 1404 may be part of a larger cluster of hardware (e.g., such as in a data center or CPE) where many hardware nodes work together and are managed via management and orchestration 1410, which, among others, oversees lifecycle management of applications 1402. In some embodiments, hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1412 which may alternatively be used for communication between hardware nodes and radio units.

In various embodiments, virtualization environment 1400 can be configured to host various network functions (NFs) and application functions (AFs) described above. In other words, these NFs and AFs can be implemented in respective virtual nodes 1402 based on underlying hardware 1404. These respective virtual nodes 1402 can be configured to perform various exemplary methods or procedures described above.

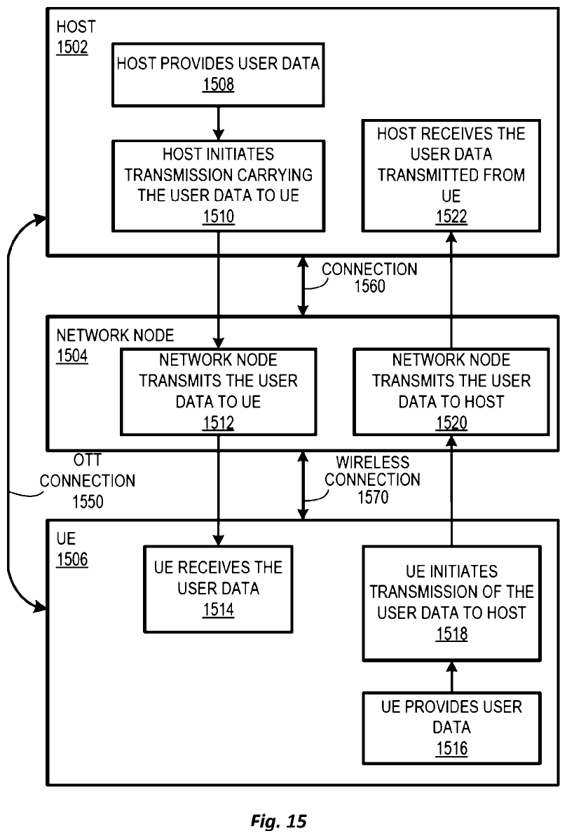

FIG. 15 shows a communication diagram of a host 1502 communicating via a network node 1504 with a UE 1506 over a partially wireless connection in accordance with some embodiments. Example implementations, in accordance with various embodiments, of the UE (such as a UE 1012a of FIG. 10 and/or UE 1100 of FIG. 11), network node (such as network node 1010a of FIG. 10 and/or network node 1200 of FIG. 12), and host (such as host 1016 of FIG. 10 and/or host 1300 of FIG. 13) discussed in the preceding paragraphs will now be described with reference to FIG. 15.

Like host 1300, embodiments of host 1502 include hardware, such as a communication interface, processing circuitry, and memory. The host 1502 also includes software, which is stored in or accessible by the host 1502 and executable by the processing circuitry. The software includes a host application that may be operable to provide a service to a remote user, such as the UE 1506 connecting via an over-the-top (OTT) connection 1550 extending between the UE 1506 and host 1502. In providing the service to the remote user, a host application may provide user data which is transmitted using the OTT connection 1550.

The network node 1504 includes hardware enabling it to communicate with the host 1502 and UE 1506. The connection 1560 may be direct or pass through a core network (like core network 1006 of FIG. 10) and/or one or more other intermediate networks, such as one or more public, private, or hosted networks. For example, an intermediate network may be a backbone network or the Internet.

The UE 1506 includes hardware and software, which is stored in or accessible by UE 1506 and executable by the UE's processing circuitry. The software includes a client application, such as a web browser or operator-specific “app” that may be operable to provide a service to a human or non-human user via UE 1506 with the support of the host 1502. In the host 1502, an executing host application may communicate with the executing client application via the OTT connection 1550 terminating at the UE 1506 and host 1502. In providing the service to the user, the UE's client application may receive request data from the host's host application and provide user data in response to the request data. The OTT connection 1550 may transfer both the request data and the user data. The UE's client application may interact with the user to generate the user data that it provides to the host application through the OTT connection 1550.

The OTT connection 1550 may extend via a connection 1560 between the host 1502 and the network node 1504 and via a wireless connection 1570 between the network node 1504 and the UE 1506 to provide the connection between the host 1502 and the UE 1506. The connection 1560 and wireless connection 1570, over which the OTT connection 1550 may be provided, have been drawn abstractly to illustrate the communication between the host 1502 and the UE 1506 via the network node 1504, without explicit reference to any intermediary devices and the precise routing of messages via these devices.

As an example of transmitting data via the OTT connection 1550, in step 1508, the host 1502 provides user data, which may be performed by executing a host application. In some embodiments, the user data is associated with a particular human user interacting with the UE 1506. In other embodiments, the user data is associated with a UE 1506 that shares data with the host 1502 without explicit human interaction. In step 1510, the host 1502 initiates a transmission carrying the user data towards the UE 1506. The host 1502 may initiate the transmission responsive to a request transmitted by the UE 1506. The request may be caused by human interaction with the UE 1506 or by operation of the client application executing on the UE 1506. The transmission may pass via the network node 1504, in accordance with the teachings of the embodiments described throughout this disclosure. Accordingly, in step 1512, the network node 1504 transmits to the UE 1506 the user data that was carried in the transmission that the host 1502 initiated, in accordance with the teachings of the embodiments described throughout this disclosure. In step 1514, the UE 1506 receives the user data carried in the transmission, which may be performed by a client application executed on the UE 1506 associated with the host application executed by the host 1502.

In some examples, the UE 1506 executes a client application which provides user data to the host 1502. The user data may be provided in reaction or response to the data received from the host 1502. Accordingly, in step 1516, the UE 1506 may provide user data, which may be performed by executing the client application. In providing the user data, the client application may further consider user input received from the user via an input/output interface of the UE 1506. Regardless of the specific manner in which the user data was provided, the UE 1506 initiates, in step 1518, transmission of the user data towards the host 1502 via the network node 1504. In step 1520, in accordance with the teachings of the embodiments described throughout this disclosure, the network node 1504 receives user data from the UE 1506 and initiates transmission of the received user data towards the host 1502. In step 1522, the host 1502 receives the user data carried in the transmission initiated by the UE 1506.

One or more of the various embodiments improve the performance of OTT services provided to the UE 1506 using the OTT connection 1550, in which the wireless connection 1570 forms the last segment. More precisely, embodiments described herein can provide a new service operation by which an NEF can request a UDM to remove authorization related to a service-specific parameter provisioning request, e.g., before a validity time for the authorization expires. Upon receiving such a request, the UDM can release and stop monitoring for updates pertaining to the resources related to the authorization This avoids waste of UDM resources (e.g., signaling, processing, storage, etc.) and facilitates more efficient operation of the 5GC. These increased efficiencies improve the delivery of OTT services via the 5GC, thereby increasing the value of such OTT services to both end users and service providers.

In an example scenario, factory status information may be collected and analyzed by the host 1502. As another example, the host 1502 may process audio and video data which may have been retrieved from a UE for use in creating maps. As another example, the host 1502 may collect and analyze real-time data to assist in controlling vehicle congestion (e.g., controlling traffic lights). As another example, the host 1502 may store surveillance video uploaded by a UE. As another example, the host 1502 may store or control access to media content such as video, audio, VR or AR which it can broadcast, multicast or unicast to UEs. As other examples, the host 1502 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1550 between the host 1502 and UE 1506, in response to variations in the measurement results.

The measurement procedure and/or the network functionality for reconfiguring the OTT connection may be implemented in software and hardware of the host 1502 and/or UE 1506. In some embodiments, sensors (not shown) may be deployed in or in association with other devices through which the OTT connection 1550 passes; the sensors may participate in the measurement procedure by supplying values of the monitored quantities exemplified above, or supplying values of other physical quantities from which software may compute or estimate the monitored quantities. The reconfiguring of the OTT connection 1550 may include message format, retransmission settings, preferred routing etc.; the reconfiguring need not directly alter the operation of the network node 1504. Such procedures and functionalities may be known and practiced in the art. In certain embodiments, measurements may involve proprietary UE signaling that facilitates measurements of throughput, propagation times, latency and the like, by the host 1502. The measurements may be implemented in that software causes messages to be transmitted, in particular empty or ‘dummy’ messages, using the OTT connection 1550 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, etc., such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

1-30. (canceled)

31. A method in a first Network Function (NF), comprising:
sending to a Nudr_GroupIDmap service of a unified data repository (UDR) a subscription request for subscribing to notifications from the UDR of a change in a mapping between NF Group Identifier (ID) and subscriber identity; and
receiving from the UDR a notification of a change in a mapping between NF Group Identifier (ID) and subscriber identity.

32. The method of claim 31, wherein
the method further comprises updating mapping information stored in the first NF in response to receiving, from the UDR, a notification of a change in a mapping between NF Group ID and subscriber identity.

33. The method of claim 31, wherein
the change includes one or more changes in one or more mappings between NF Group ID and subscriber identity for one or more NF Types.

34. The method of claim 31, wherein
the notification includes:
UE identity or list of ranges of UE identities for which the mapping is changed,
NF Group ID for which the mapping is changed, and
NF Type for which the mapping is changed.

35. The method of claim 31, wherein
the subscription request includes:
a callback URI where the first NF receives the notification from the UDR,
a subscription condition indicator indicating one or more mappings between NF Group ID and subscriber identity to be monitored for change, with respect to one or more NF types.

36. The method of claim 35, wherein
the subscription condition includes:
NF Group ID for which mapping between NF Group ID and UE identity is to be monitored for change,
a list of ranges of UE identities whose mapping with NF Group ID is to be monitored for change, and/or
a list of subscription identifiers.

37. The method of claim 35, wherein
the subscription request further comprises:
a NF instance ID of the first NF;
a subscription ID for newly created resource, which is set to be absent in the subscription request; and/or
a validity time indicating a time instance after which the subscription becomes invalid.

38. The method of claim 31, wherein
the method further comprises receiving, from the UDR, a subscription response to the subscription request, wherein the subscription response includes subscription ID for newly created resource and includes validity time indicating a time instance after which the subscription becomes invalid.

39. The method of claim 31, wherein
the method further comprises, if the notification indicates that the subscriber identity is moved to a mapping with another NF Group ID, sending, to the UDR, another subscription request for subscribing notification of change in the mapping with respect to the other NF Group ID.

40. A non-transitory computer-readable storage medium storing computer-executable instructions for configuring a network function to perform the method of claim 31.

41. A method in a unified data repository (UDR), the method comprising:
receiving, from a first network function (NF), a subscription request for subscribing to notifications of a change in a mapping between NF Group Identifier (ID) and subscriber identity; and
sending, to a first NF, a notification of a change in a mapping between NF Group Identifier (ID) and subscriber identity, when a mapping change occurs in the UDR.

42. The method of claim 41, wherein
the method further comprises sending, to the first NF, a subscription response to the subscription request, wherein the subscription response includes subscription ID for newly created resource and includes validity time indicating a time instance after which the subscription becomes invalid.

43. The method of claim 41, wherein
receiving, if the notification indicates that UE identity is moved to a mapping with another NF Group ID, from the first NF, another subscription request for subscribing notification of change in the mapping with respect to the other NF Group ID.

44. The method of claim 41, wherein
the first NF includes a NF consumer, a NF Repository Function, NRF or a Service Communication Proxy (SCP).

45. The method of claim 41, wherein
the notification includes:
UE identity or list of ranges of UE identities for which the mapping is changed,
NF Group ID for which the mapping is changed, or
NF Type for which the mapping is changed.

46. A non-transitory computer-readable storage medium storing computer-executable instructions for configuring a UDR to perform the method of claim 41.

47. A first network function (NF), comprising:
a processor, and
a memory coupled to the processor, the memory containing instructions executable by the processor, wherein the first NF is configured to perform a method comprising:
sending to a Nudr_GroupIDmap service of a unified data repository (UDR) a subscription request for subscribing to notifications from the UDR of a change in a mapping between NF Group Identifier (ID) and subscriber identity; and
receiving from the UDR a notification of a change in a mapping between NF Group Identifier (ID) and subscriber identity.

48. A unified data repository (UDR), comprising:
a processor; and
a memory coupled to the processor, the memory containing instructions executable by the processor, wherein the UDR is configured to perform a method comprising:
receiving, from a first network function (NF), a subscription request for subscribing to notifications of a change in a mapping between NF Group Identifier (ID) and subscriber identity; and
sending, to a first NF, a notification of a change in a mapping between NF Group Identifier (ID) and subscriber identity, when a mapping change occurs in the UDR.
